(19) United States
(12) Patent Application Publication
(10) Pub. No.: US 2014/0366084 A1
(43) Pub. Date: Dec. 11, 2014

(54) MANAGEMENT SYSTEM, MANAGEMENT METHOD, AND NON-TRANSITORY STORAGE MEDIUM

(71) Applicant: NEC CORPORATION, Tokyo (JP)

(72) Inventor: Ryuichi Ogawa, Tokyo (JP)

(73) Assignee: NEC CORPORATION, Minato-ku, Tokyo (JP)

(21) Appl. No.: 14/374,421

(22) PCT Filed: Jan. 16, 2013
(86) PCT No.: PCT/JP2013/000156

§ 371 Date: Jul. 24, 2014

(30) Foreign Application Priority Data
Jan. 25, 2012 (JP) 2012-013455

(51) Int. Cl. H04L 29/06; H04L 12/911

(52) U.S. Cl. CPC H04L 63/20; H04L 63/10; H04L 47/70
USPC 726/1

(57) ABSTRACT

There is provided a management system (10) including a transmission information acquisition unit (11) that acquires transmission information indicating that resources held in a resource holding unit (31) are to be transmitted to an external data center, an extraction unit (12) that extracts a first security policy, which is a security policy applied to an application to be transmitted and is a security policy to be realized in the external data center, from a security policy holding unit (32) that holds the security policy applied to the application when the transmission information acquisition unit (11) acquires the transmission information, an acquisition unit (14) that acquires security information, which indicates a security function realizable in the external data center, from the external data center when the transmission information acquisition unit (11) acquires the transmission information, and a determination unit (13) that determines whether or not the first security policy is realizable in the external data center based on the security information.

### TECHNICAL FIELD

The present invention relates to a management system, a management method, and a program.

### BACKGROUND ART

In applications executed in a data center or the like, an appropriate security policy is set according to the processing content of each application, information that is handled, and the like, and safe management is performed by following the security policy.

Patent Document 1 discloses a security management system to realize an improvement in the security of a network system and a reduction in the load of the system administrator.

The security management system includes an input device, a node database, a function mapping processing unit, and an output device. The security policy and topology information of a system to be managed are input to the input device. The security policy is described independently of software or hardware that is a node of the system to be managed. Node knowledge describing a security function of each node is stored in the node database. The function mapping processing unit correlates each rule included in the security policy with each node indicated by the topology information, through the security function, by referring to the node knowledge. Then, the correspondence relationship is output to the output device as a function map.

Patent Document 2 discloses a management apparatus for checking whether or not an object to be managed suits a security policy by applying a correct security policy even if the security policy to be applied to the object to be managed changes.

### RELATED DOCUMENT

### Patent Document

[Patent Document 1] Japanese Unexamined Patent Publication No. 2004-342072
[Patent Document 2] Japanese Unexamined Patent Publication No. 2009-15585

### DISCLOSURE OF THE INVENTION

The present inventors have found the following problems in the management of the application using the security policy.

In a data center or the like, one or more applications are executed using various resources, such as a server, a storage device, a network, a program, and data. It is preferable that such resources be provided at safe locations to minimize changes, such as transferring of the resources. However, with the spread of cloud in recent years, a situation may occur in which resources provided in the data center managed by an own company are transmitted to the data center managed by the cloud service provider. As a result, it is thought that there is a possibility that the transmission frequency of resources will be increased. In addition, it can also be thought that there is a possibility that the dynamic transmission (relatively urgent transmission or the like) of resources will occur due to natural disasters, the performance of an application, and the like.

However, as described above, in the application, an appropriate security policy is set, and safe management is performed by following the security policy. For this reason, when transmitting the resources, it is necessary to take steps of checking whether or not the security policy set for the application to be transmitted can be realized in the data center of the transmission destination (checking work) and transmitting the resources when the security policy can be realized, before the actual transmission.

In the related art, the checking work described above has been performed by a person on the assumption that transmission is performed as planned in advance. That is, a person has performed the work, such as checking a security policy set for an application to be transmitted, inquiring of the administrator of the transmission destination whether or not the security policy can be realized in the data center of the transmission destination or inquiring of the administrator of the transmission destination about the security function of the transmission destination, and performing determination based on the content. In this case, there is a problem in that transmission work does not proceed smoothly and too much time and effort are required. For example, when the management of an application in a current data center becomes difficult and a situation where the resources should be quickly transmitted occurs dynamically, such a loss of time may cause a big problem depending on the processing content of the application.

Therefore, it is an object of the present invention to provide a technique that can efficiently advance the transmission of resources to realize an application.

According to the present invention, there is realized a management system including: a transmission information acquisition unit that acquires transmission information indicating that resources to realize an application held in a resource holding unit are to be transmitted to an external data center; an extraction unit that extracts a first security policy, which is a security policy applied to the application to be transmitted and is a security policy to be realized in the external data center, from a security policy holding unit that holds the security policy applied to the application when the transmission information acquisition unit acquires the transmission information; an acquisition unit that acquires security information, which indicates a security function realizable in the external data center, from the external data center when the transmission information acquisition unit acquires the transmission information; and a determination unit that determines whether or not the first security policy is realizable in the external data center based on the security information.

In addition, according to the present invention, there is realized a management system including: a transmission information acquisition unit that acquires transmission information indicating that resources to realize an application held in a resource holding unit are to be transmitted to an external data center; an extraction unit that extracts a first security policy, which is a security policy applied to the application to be transmitted and is a security policy to be realized in the external data center, from a security policy holding unit that holds the security policy applied to the application when the transmission information acquisition unit acquires the transmission information; and an inquiry unit that inquires of the external data center whether or not the first security policy is realizable in the external data center and acquires a reply from the external data center.

In addition, according to the present invention, there is realized a management system that receives resources to realize an application from an external data center. The management system includes: a security information holding unit that holds security information indicating a security function realizable in a data center of a receiving destination; a transmission request receiving unit that receives a request for transmission of the security information from the external data center; and a security information transmission unit that takes out the security information from the security information holding unit and transmits the security information to the external data center when the transmission request receiving unit receives the request for transmission.

In addition, according to the present invention, there is provided a management system that receives resources to realize an application from an external data center. The management system includes: a security information holding unit that holds security information indicating a security function realizable in a data center of a receiving destination; an inquiry receiving unit that receives, from the external data center, an inquiry regarding whether or not a predetermined security policy is realizable in the data center of the receiving destination; a checking unit that determines whether or not the predetermined security policy is realizable in the data center of the receiving destination based on the security information when the inquiry receiving unit receives the inquiry; and a reply transmission unit that transmits a determination result of the checking unit to the external data center.

In addition, according to the present invention, there is provided a program causing a computer to function as: a transmission information acquisition unit that acquires transmission information indicating that resources to realize an application held in a resource holding unit are to be transmitted to an external data center; an extraction unit that extracts a first security policy, which is a security policy applied to the application to be transmitted and is a security policy to be realized in the external data center, from a security policy holding unit that holds the security policy applied to the application when the transmission information acquisition unit acquires the transmission information; an acquisition unit that acquires security information, which indicates a security function realizable in the external data center, from the external data center when the transmission information acquisition unit acquires the transmission information; and a determination unit that determines whether or not the first security policy is realizable in the external data center based on the security information.

In addition, according to the present invention, there is provided a program causing a computer to function as: a transmission information acquisition unit that acquires transmission information indicating that resources to realize an application held in a resource holding unit are to be transmitted to an external data center; an extraction unit that extracts a first security policy, which is a security policy applied to the application to be transmitted and is a security policy to be realized in the external data center, from a security policy holding unit that holds the security policy applied to the application when the transmission information acquisition unit acquires the transmission information; and an inquiry unit that inquires of the external data center whether or not the first security policy is realizable in the external data center and acquires a reply from the external data center.

In addition, according to the present invention, there is provided a program for receiving resources to realize an application from an external data center. The program causes a computer to function as: a security information holding unit that holds security information indicating a security function realizable in a data center of a receiving destination; a transmission request receiving unit that receives a request for transmission of the security information from the external data center; and a security information transmission unit that takes out the security information from the security information holding unit and transmits the security information to the external data center when the transmission request receiving unit receives the request for transmission.

In addition, according to the present invention, there is provided a program for receiving resources to realize an application from an external data center. The program causes a computer to function as: a security information holding unit that holds security information indicating a security function realizable in a data center of a receiving destination; an inquiry receiving unit that receives, from the external data center, an inquiry regarding whether or not a predetermined security policy is realizable in the data center of the receiving destination; a checking unit that determines whether or not the predetermined security policy is realizable in the data center of the receiving destination based on the security information when the inquiry receiving unit receives the inquiry; and a reply transmission unit that transmits a determination result of the checking unit to the external data center.

In addition, according to the present invention, there is provided a management method causing a computer to execute: a transmission information acquisition step of acquiring transmission information indicating that resources to realize an application held in a resource holding unit are to be transmitted to an external data center; an extraction step of extracting a first security policy, which is a security policy applied to the application to be transmitted and is a security policy to be realized in the external data center, from a security policy holding unit that holds the security policy applied to the application when the transmission information is acquired in the transmission information acquisition step; an acquisition step of acquiring security information, which indicates a security function realizable in the external data center, from the external data center when the transmission information is acquired in the transmission information acquisition step; and a determination step of determining whether or not the first security policy is realizable in the external data center based on the security information.

In addition, according to the present invention, there is provided a management method causing a computer to execute: a transmission information acquisition step of acquiring transmission information indicating that resources to realize an application held in a resource holding unit are to be transmitted to an external data center; an extraction step of extracting a first security policy, which is a security policy applied to the application to be transmitted and is a security policy to be realized in the external data center, from a security policy holding unit that holds the security policy applied to the application when the transmission information is acquired in the transmission information acquisition step; and an inquiry step of inquiring of the external data center whether or not the first security policy is realizable in the external data center and acquiring a reply from the external data center.

In addition, according to the present invention, there is provided a management method for receiving resources to realize an application from an external data center. The method causes a computer to execute: a transmission request receiving step of receiving a request for transmission of security information from the external data center; and a security information transmission step of taking out the security information from a security information holding unit, which holds security information indicating a security function realizable in a data center of a receiving destination, and transmitting the security information to the external data center when the request for transmission is received in the transmission request receiving step.

In addition, according to the present invention, there is provided a management method for receiving resources to realize an application from an external data center. The method causes a computer to execute: an inquiry receiving step of receiving, from the external data center, an inquiry regarding whether or not a predetermined security policy is realizable in a data center of the receiving destination; a checking step of determining whether or not the predetermined security policy is realizable in the data center of the receiving destination based on security information, which indicates a security function realizable in the data center of the receiving destination and is held in a security information holding unit, when the inquiry is received in the inquiry receiving step; and a reply transmission step of transmitting a determination result in the checking step to the external data center.

According to the present invention, it is possible to efficiently advance the transmission of resources to realize an application.

### BRIEF DESCRIPTION OF THE DRAWINGS

The above-described object and other objects, features, and advantages will become more apparent by preferred exemplary embodiments described below and the following accompanying drawings.

FIG. 1 is an example of a functional block diagram of a first exemplary embodiment.

FIG. 2 is an example of a security policy held in a security policy holding unit.

FIG. 3 is an example of data that can be held in the security policy holding unit.

FIG. 4 is an example of data that can be held in an extraction unit.

FIG. 5 is an example of security information.

FIG. 6 is an example of data that can be held in an acquisition unit and an inquiry unit.

FIG. 7 is an example of data that can be held in a determination unit and a checking unit.

FIG. 8 is an example of data that can be held in the security policy holding unit.

FIG. 9 is a sequence diagram showing an example of the process flow of a management method of the first exemplary embodiment.

FIG. 10 is an example of a functional block diagram of a second exemplary embodiment.

FIG. 11 is a sequence diagram showing an example of the process flow of a management method of the second exemplary embodiment.

FIG. 12 is an example of a functional block diagram of a third exemplary embodiment.

FIG. 13 is a sequence diagram showing an example of the process flow of a management method of the third exemplary embodiment.

FIG. 14 is an example of a functional block diagram of a fourth exemplary embodiment.

FIG. 15 is a sequence diagram showing an example of the process flow of a management method of the fourth exemplary embodiment.

### DESCRIPTION OF EXEMPLARY EMBODIMENTS

Hereinafter, exemplary embodiments of the present invention will be described with reference to the diagrams.

In addition, a system of the present exemplary embodiment is realized by any combination of hardware and software based on a CPU and a memory of an arbitrary computer, a program loaded into the memory (including not only a program stored in the memory in advance from the step of shipping the apparatus but also a program downloaded from storage media such as a CD, a server on the Internet, or the like), a storage unit such as a hard disk that stores the program, and an interface for network connection. In addition, it will be understood by those skilled in the art that various modifications of the implementation method and the apparatus can be made.

In addition, a functional block diagram used to explain the present exemplary embodiment does not show a configuration of a hardware unit but shows a block of a functional unit. Although each apparatus is realized by one device in these diagrams, the implementation means is not limited thereto. That is, a physically divided configuration or a logically divided configuration may also be adopted.

### First Exemplary Embodiment

### Entire Image

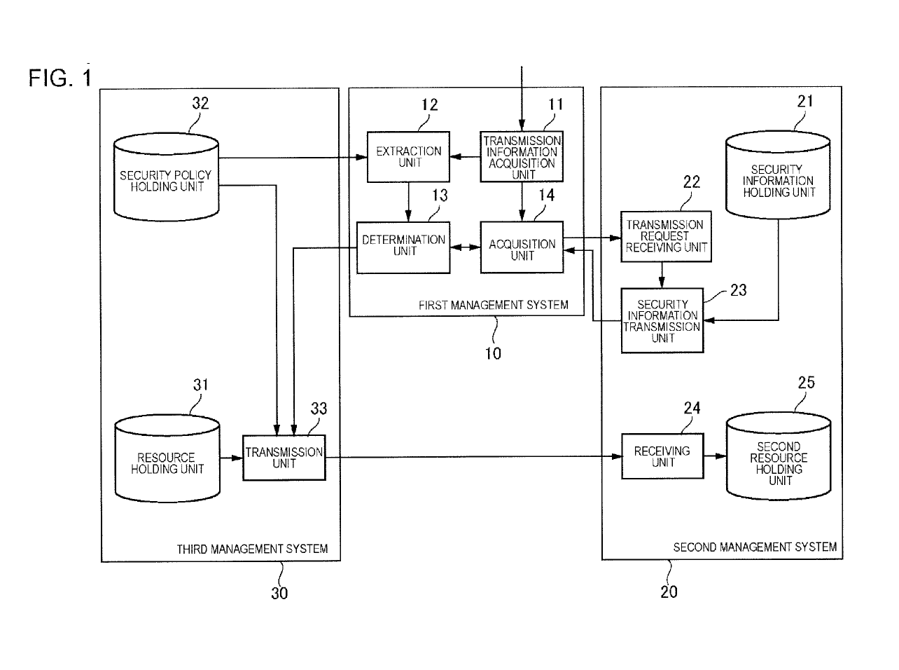

First, an entire image of the present exemplary embodiment will be described with reference to FIG. 1. A first management system 10 of the present exemplary embodiment assists a process of transmitting resources held in a third management system 30 (transmission source) to a second management system 20 (transmission destination).

The third management system 30 is provided in the data center of the transmission source. The first management system 10 is communicably connected to the third management system 30 by a cable and/or wirelessly. The first management system 10 may be provided in the same data center as the third management system 30, or may be provided in a physically separate location (in other data centers or the like) and be connected to the third management system 30 through the Internet, a wide area network (WAN), or the like. The second management system 20 is provided in a physically separate location (data center of the transmission destination) from the first and third management systems 10 and 30, and is connected to the first and third management systems 10 and 30 through the Internet, a WAN, or the like. Next, each system will be described in detail.

### <Third Management System 30>

As shown in FIG. 1, the third management system 30 includes a resource holding unit 31, a security policy holding unit 32, and a transmission unit 33.

The resource holding unit 31 holds resources to realize a predetermined application. Then, a processing unit (not shown) executes the predetermined application using the resources held in the resource holding unit 31. The resources held in the resource holding unit 31 are resources that can be transmitted through a network, such as the Internet. For example, electronic data, such as data or a program, corresponds to the resources. Hereinafter, the resources held in the resource holding unit 31 are simply referred to as “resources”. That is, the “resources” referred to below do not include resources, such as a network or a server that cannot be transmitted through a network. The resource holding unit 31 can hold resources for realizing one or more applications. When the resource holding unit 31 holds resources regarding a plurality of applications, the resource holding unit 31 holds the resources in a manner in which the resources used for each application can be identified. Since the specific means can be implemented according to the conventional technique, explanation thereof will not be repeated herein.

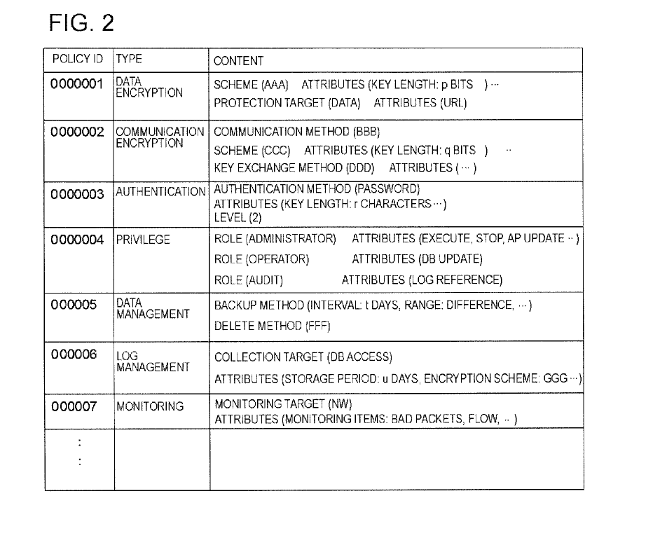

The security policy holding unit 32 holds a security policy applied to an application that is realized using the resources held in the resource holding unit 31. The security policy may be set for each application. FIG. 2 shows an example of the security policy held in the security policy holding unit 32. In the example shown in FIG. 2, the content of each security policy (in the diagram, “content”) is recorded so as to be associated with the ID of each security policy (in the diagram, “policy ID”). In addition, as in the example shown in FIG. 2, the type of each security policy (in the diagram, “type”) can be recorded so as to be associated with the ID of each security policy (in the diagram, “policy ID”).

The security policy of the policy ID “000001” shown in FIG. 2 is a security policy regarding “data encryption”, and a name AAA of the scheme of data encryption allowed (specifically, RC6, DES, TripleDES, and the like) and the length (p bits) of the key allowed in data encryption are set as attributes of the scheme. As other attributes, a block length, the number of times of round, and the like may be specified. In this policy, an encryption target (data) and the attributes (URL of a data file and the like) are defined. As the encryption target, a disk volume or a password may be specified.

The security policy of the policy ID “000002” is a security policy regarding “communication encryption”, and an allowed communication method BBB (specifically, SSL, IPsec, HTTPS, and the like), a name CCC of the scheme of encryption (specifically RC6, DES, TripleDES, and the like), and the length (q bits) of the key allowed in communication encryption are set as attributes of the scheme. As other attributes, a block length, the number of times of round, and the like may be specified. In this policy, it is possible to specify an exchange method DDD (specifically, DHM, MQV, IKE, and the like) of the key shared between communication nodes or the attributes.

The security policy of the policy ID “000003” is a security policy regarding “authentication”, and a password as the name of the authentication scheme allowed, a key length as an attribute of the scheme (in this case, a password length of r characters), and an authentication level (2) allowed are set. The authentication level is assumed to be separately defined by an indicator showing the strength of authentication. As the authentication scheme, a token (card), a body, a composite form thereof, and the like can be specified.

The security policy of the policy ID “000004” is a security policy regarding “privilege”, and the role (job title, role, and the like) of privileged users that can use the application are set. That is, for the application to which the security policy of the policy ID “000004” is applied, a user with an “administrator” role can perform operations of executing, stopping, and updating the application, a user with an “operator” role can perform a DB update operation, and a user with an “audit” role can perform a log file reference operation.

The security policy of the policy ID “000005” is a security policy regarding “data management”, and the interval (t days or less) of data backup and the range (difference) of data to be backed up are set. In addition, a data deletion method FFF at the end of service (specifically, an NSA method and the like) is set.

The security policy of the policy ID “000006” is a security policy regarding “log management”, and events (DB access) to be collected, a log retention period (u days or more), a log file encryption method GGG, and the like are set as attributes.

The security policy of the policy ID “000007” is a security policy regarding “monitoring”, and computation resources (network) to be monitored and monitoring items (bad packets, network flow, and the like) as monitoring attributes are set.

The above-described examples of the security policy are just examples, and other content may be included, or one or more of those exemplified may not be included.

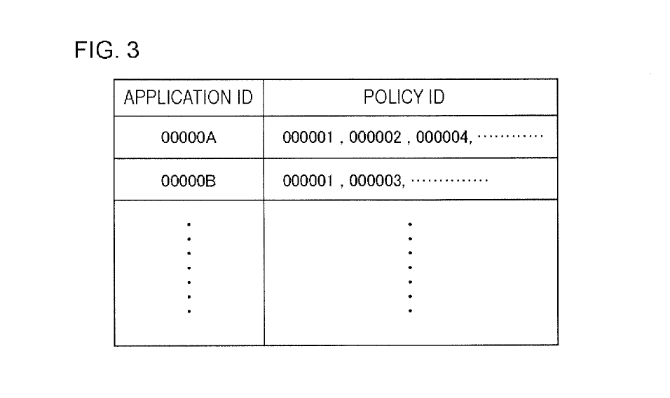

In addition, the security policy holding unit 32 can hold information, in which applications and policy IDs applied to the respective applications are correlated with each other, as shown in FIG. 3. The application herein is an application realized by the resources held in the resource holding unit 31. According to the information shown in FIG. 3, it is set that the security policies of the policy IDs “000001”, “000002”, “000004”, and the like are applied to the application of the application ID “00000A”.

Referring back to FIG. 1, when a determination unit 13 of the first management system 10 determines that a predetermined security policy (first security policy) can be realized in the data center of the transmission destination (candidate), the transmission unit 33 takes out resources to realize an application, which is to be transmitted, from the resource holding unit 31 and transmits the resources to the data center of the transmission destination. Detailed explanation of the transmission unit 33 will be given after explanation of the first management system 10.

### <First Management System 10>

As shown in FIG. 1, the first management system 10 includes a transmission information acquisition unit 11, an extraction unit 12, the determination unit 13, and an acquisition unit 14.

The transmission information acquisition unit 11 acquires transmission information indicating that the resources held in the resource holding unit 31 are to be transmitted to the external data center. When the resource holding unit 31 holds the resources regarding a plurality of applications, information specifying an application to be transmitted may be included in the transmission information. In addition, information (IP address or the like) specifying the external data center of the transmission destination (candidate) may be included in the transmission information.

As means for acquiring the transmission information by the transmission information acquisition unit 11, all kinds of modes can be considered. For example, the transmission information acquisition unit 11 may realize the acquisition of transmission information by acquiring the transmission information input to the first management system 10 by the user (administrator or the like of the third management system 30). In this case, when a situation occurs in which resources to realize a certain application is to be transmitted to the external data center, the user (administrator or the like of the third management system 30) inputs the transmission information to the third management system. In this case, information specifying an application to be transmitted or information (address or the like) specifying the external data center of the transmission destination (candidate) may be included in the transmission information. In addition, the input of transmission information can be realized using all kinds of input devices, such as a keyboard, a mouse, an input button, a touch panel display, and a microphone.

As other means for acquiring the transmission information by the transmission information acquisition unit 11, the transmission information acquisition unit 11 may be configured so as to be able to communicate with a monitoring device (not shown) that monitors the state of an application realized by using the resources held in the resource holding unit 31, and some of messages (for example, a message indicating that a failure of a predetermined level or more has occurred and a message indicating that a predetermined threshold value (the number of accesses, the volume of communication, or the like) determined by the service level agreement (SLA) has been exceeded) indicating the state of the application that are acquired by the monitoring device may be acquired as transmission information. In this case, information specifying an application to be transmitted may be included in the transmission information.

After the transmission information acquisition unit 11 acquires the transmission information, the extraction unit 12 extracts the first security policy, which is a security policy applied to the application to be transmitted and is a security policy to be realized in the data center of the transmission destination, from the security policy holding unit 32. In addition, security policies to be realized in the data center of the transmission destination may be all security policies applied to the application to be transmitted (all security policies applied to the application in the data center before transmission), or may be some of the security policies (some of security policies applied to the application in the data center before transmission). An application to which the former is applied and an application to which the latter is applied may be mixed.

When the security policies to be realized in the data center of the transmission destination are all security policies applied to an application to be transmitted, the extraction unit 12 extracts all security policies correlated with a specified application, as the first security policy, with reference to the information (information in which applications and policy IDs applied to the respective applications are correlated with each other) shown in the FIG. 3, which is held in the security policy holding unit 32, when the application to be transmitted is specified using the transmission information.

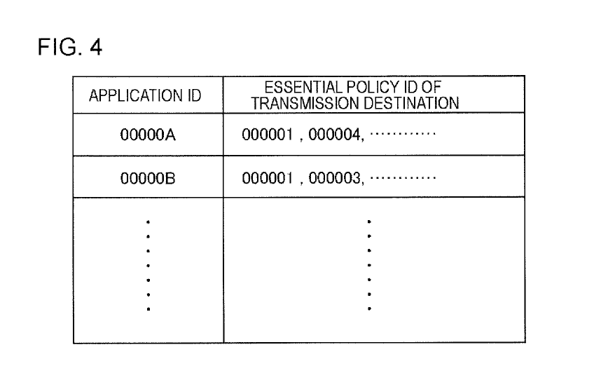

On the other hand, when the security policies to be realized in the data center of the transmission destination are some of security policies applied to an application to be transmitted, the extraction unit 12 can hold the information shown in FIG. 4, in which applications and security policies to be realized in the data center of the transmission destination are correlated with each other in advance, and by referring to the information, the extraction unit 12 can extract all security policies correlated with a specified application as the first security policy.

Referring back to FIG. 1, after the transmission information acquisition unit 11 acquires the transmission information, the acquisition unit 14 acquires security information, which indicates a security function that can be realized in the external data center, from the external data center (second management system 20 provided in the data center) of the transmission destination (candidate).

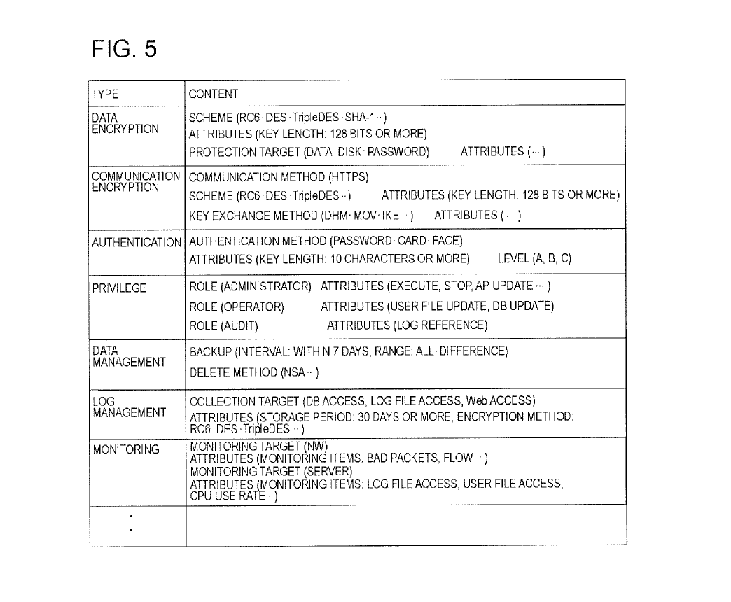

FIG. 5 shows an example of security information. In the security information shown in FIG. 5, the content of security functions that can be realized by the system is described for each of a plurality of types. A scheme name (MD6•DES•TripleDES•SHA-1••), a key length (128 bits or more), an object to be protected (data, a disk, a password), and the like, which can be used for “data encryption” in the data center, are described in the security information shown in FIG. 5. In addition, a communication method, the name of the encryption scheme, a key length, a key exchange method, and the like, which can be used for “communication encryption” in the data center, are described. In addition, the name of the scheme and the authentication level, which can be used for “authentication” in the data center, are described. Similarly for each security function of “privilege”, “data management”, “log management”, and “monitoring”, attribute values of methods that can be used in the data center are described comprehensively. The security information shown in FIG. 5 is just an example, and other content may be included, or one or more of those exemplified may not be included. When security information is described for each type as shown in FIG. 5, comparison with the security policy held in the security policy holding unit 32 of the third management system 30 becomes easy.

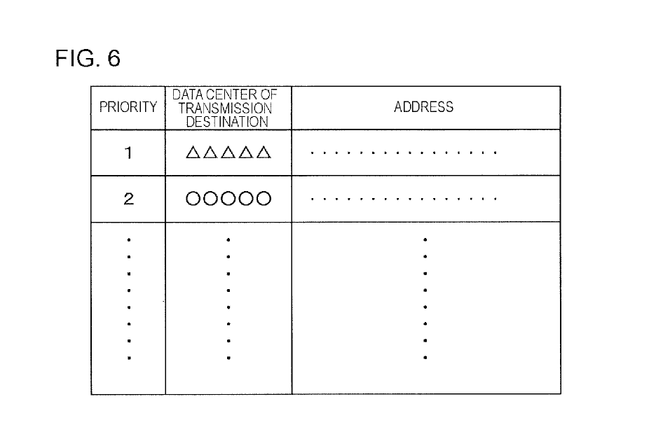

As means for specifying the external data center (second management system 20 provided in the data center) of the communication partner by the acquisition unit 14, all kinds of modes can be considered. For example, when information (IP address or the like) specifying the external data center of the transmission destination (candidate) is included in the transmission information, the acquisition unit 14 may specify the external data center of the communication partner using the information. Alternatively, the acquisition unit 14 may hold a list of data centers of the transmission destination (candidate) shown in FIG. 6 in advance, and specify the external data center of the communication partner using the list. In the list shown in FIG. 6, addresses (IP addresses or the like) of the data centers of a plurality of transmission destinations (candidates) are registered, and the priorities of transmission are given. The acquisition unit 14 may acquire the security information in order from the high-priority data center.

Referring back to FIG. 1, the determination unit 13 determines whether or not the first security policy can be realized in the data center of the transmission destination (candidate) based on the security information. For example, when the first security policy (some of the security policies shown in FIG. 2) and the security information (refer to FIG. 5) are acquired, the determination unit 13 can determine, for each security policy, whether or not the security policy can be realized in the data center of the transmission destination (candidate). When a plurality of security policies are included in the first security policy, the determination unit 13 may determine that the first security policy can be realized in the data center of the transmission destination (candidate) if all of the plurality of security policies included in the first security policy can be realized in the data center of the transmission destination (candidate).

Here, an example of the process of the determination unit 13 will be described in detail. For example, it is assumed that only the policy IDs “000001” and “000003” shown in FIG. 2 are included in the first security policy extracted by the extraction unit 12. In addition, it is assumed that the acquisition unit 14 acquires the security information shown in FIG. 5 as security information.

First, the determination unit 13 searches the column of “type” of security information (refer to FIG. 5) using the type “data encryption” of the policy ID “000001” (refer to FIG. 2) as a key, and specifies a security function of “data encryption” that can be realized in the data center of the transmission destination (candidate). Then, by comparing the content (refer to FIG. 2) of the security policy of the policy ID “000001” with the security function of “data encryption” that can be realized in the data center of the transmission destination (candidate), it is determined whether or not the security policy of the policy ID “000001” can be realized in the data center of the transmission destination (candidate). Specifically, it is checked whether or not the attribute value of the transmission source policy matches the attribute value of the transmission destination security information, or it is checked whether or not the attribute value of the transmission source policy is included in a specified range (for example, equal to or greater than the attribute value of the transmission destination security information or equal to or less than the attribute value of the transmission destination security information). Attributes (URLs of data files or the like) depending on the configuration of the transmission source and the transmission destination do not need to be compared. In addition, when the attribute value is a method name or the like, it may be determined that methods of different notations match each other even if they do not exactly match using a known method, such as a synonym dictionary.

Here, it is assumed that the determination unit 13 determines that the security policy of the policy ID “000001” can be realized in the data center of the transmission destination (candidate).

Then, the determination unit 13 searches the column of “type” of security information (refer to FIG. 5) using the type “authentication” of the policy ID “000003” (refer to FIG. 2) as a key, and specifies a security function of “authentication” that can be realized in the data center of the transmission destination (candidate). Then, the content (refer to FIG. 2) of the security policy of the policy ID “000003” is compared with the security function of “authentication” that can be realized in the data center of the transmission destination (candidate).

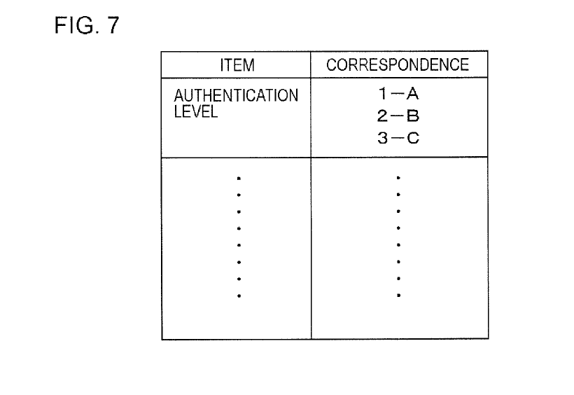

In the transmission source and the transmission destination, notations of each type may be different. For example, in the case of “authentication level” of “authentication”, notation using numerical values or notation using the alphabet can be considered. Therefore, the determination unit 13 may hold a dictionary such as shown in FIG. 7, in which the correspondence relationship of the notation is recorded, in advance and perform the above-described comparison using the dictionary. According to the dictionary shown in FIG. 7, it is shown that authentication levels “1” and “A” are the same level, authentication levels “2” and “B” are the same level, and authentication levels “3” and “C” are the same level.

When it is determined that the security policy of the policy ID “000003” can be realized in the data center of the transmission destination (candidate), all of the first security policy can be realized in the data center of the transmission destination (candidate). Accordingly, the determination unit 13 determines that the first security policy can be realized in the data center of the transmission destination (candidate). On the other hand, when it is determined that the security policy of the policy ID “000003” cannot be realized in the data center of the transmission destination (candidate), some of the first security policy cannot be realized in the data center of the transmission destination (candidate). Accordingly, the determination unit 13 determines that the first security policy cannot be realized in the data center of the transmission destination (candidate).

When it is determined that the first security policy can be realized in the data center of the transmission destination (candidate), the determination unit 13 can transmit information indicating the situation to the transmission unit 33. In the information transmitted herein, information specifying an application to be transmitted and information (IP address or the like) specifying the data center (second management system 20 provided in the data center) of the transmission destination may be included.

When the above information is acquired, the transmission unit 33 specifies the application to be transmitted and the data center of the transmission destination. Then, resources to realize the application to be transmitted are taken out from the resource holding unit 31, and are transmitted to the data center (second management system 20 provided in the data center) of the transmission destination. In this case, the transmission unit 33 may also transmit the security policy, which is applied to the application, to the data center (second management system 20 provided in the data center) of the transmission destination.

For example, as the resources to realize the application to be transmitted, a virtual machine image including application software (a data format describing a virtual machine, and application software and setting data operated on the virtual machine, in a bootable form) is stored in the resource holding unit 31. As a standard data format of the virtual machine image, there is an open virtualization format (OVF). When the OVF is used, attributes of the virtual machine image can be added as metadata. For example, the transmission unit 33 may additionally write the security policy applied to the application in the virtual machine image. Undoubtedly, the transmission unit 33 may transmit the security policy separately.

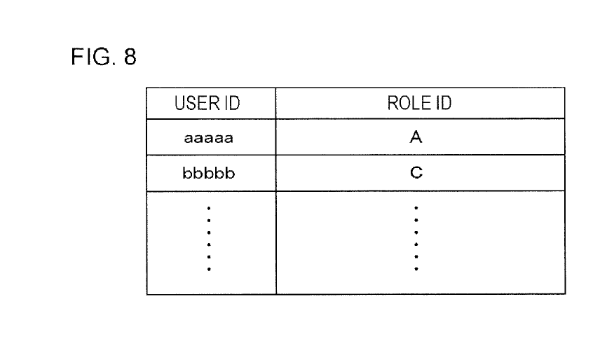

When information regarding the type “privilege” shown in FIG. 2 is included in the security policy, the transmission unit 33 may also transmit information (refer to FIG. 8), in which the ID of each user who may use the application and the role (job title, role, and the like) of each user are correlated with each other, to the data center (second management system 20 provided in the data center) of the transmission destination. The information may be held in the security policy holding unit 32.

The privilege information including IDs and roles are finally used in ID management software and authentication software. Since exchanging the ID and role information between ID management software is commonly performed, the transmission unit 33 may notify ID management software corresponding to the third management system of the privilege information including IDs and roles and the transmission destination (second management system), and the ID management software may notify ID management software corresponding to the second management system of the privilege information using a known method.

On the other hand, when it is determined that the first security policy cannot be realized in the data center of the transmission destination (candidate), the determination unit 13 may output information indicating the situation to the user (administrator or the like of the third management system). Together with this information, the determination unit 13 may output information for discriminating between the first security policy that can be realized in the data center of the transmission destination (candidate) and the first security policy that cannot be realized in the data center of the transmission destination (candidate). The output can be realized using all kinds of output devices, such as a display, a speaker, a printer, and an e-mail.

In addition, when it is determined that the first security policy cannot be realized in the data center of the transmission destination (candidate), the determination unit 13 may transmit information indicating the situation to the acquisition unit 14. In this case, the acquisition unit 14 may acquire security information from the data center of the next highest priority using the list of candidates for the transmission destinations shown in FIG. 6, for example. Then, the determination unit 13 may perform the same process as described above using the security information newly acquired by the acquisition unit 14.

The first management system 10 of the present exemplary embodiment can be realized by installing the following program in a computer, for example.

A program causing a computer to function as: a transmission information acquisition unit that acquires transmission information indicating that resources to realize an application held in a resource holding unit are to be transmitted to an external data center; an extraction unit that extracts a first security policy, which is a security policy applied to the application to be transmitted and is a security policy to be realized in the external data center, from a security policy holding unit that holds the security policy applied to the application when the transmission information acquisition unit acquires the transmission information; an acquisition unit that acquires security information, which indicates a security function realizable in the external data center, from the external data center when the transmission information acquisition unit acquires the transmission information; and a determination unit that determines whether or not the first security policy is realizable in the external data center based on the security information.

### <Second Management System 20>

As shown in FIG. 1, in order to receive resources transmitted from the external data center, the second management system 20 includes a security information holding unit 21, a transmission request receiving unit 22, a security information transmission unit 23, a receiving unit 24, and a second resource holding unit 25.

The security information holding unit 21 holds security information (refer to FIG. 5) indicating a security function that can be realized in its own data center (data center of the receiving destination).

The transmission request receiving unit 22 receives a security information transmission request from the external data center (first management system 10 provided in the data center) through a network, such as the Internet.

When the transmission request receiving unit 22 receives the request for transmission, the security information transmission unit 23 takes out the security information from the security information holding unit 21, and transmits the security information to the external data center (first management system 10 provided in the data center) that has transmitted the request for transmission.

The receiving unit 24 receives the resources transmitted from the external data center (third management system 30 provided in the data center), and stores the resources in the second resource holding unit 25.

The second management system 20 of the present exemplary embodiment can be realized by installing the following program in a computer, for example.

A program for receiving resources to realize an application from an external data center, the program causing a computer to function as: a security information holding unit that holds security information indicating a security function realizable in a data center of a receiving destination; a transmission request receiving unit that receives a request for transmission of the security information from the external data center; and a security information transmission unit that takes out the security information from the security information holding unit and transmits the security information to the external data center when the transmission request receiving unit receives the request for transmission.

### <Process Flow>

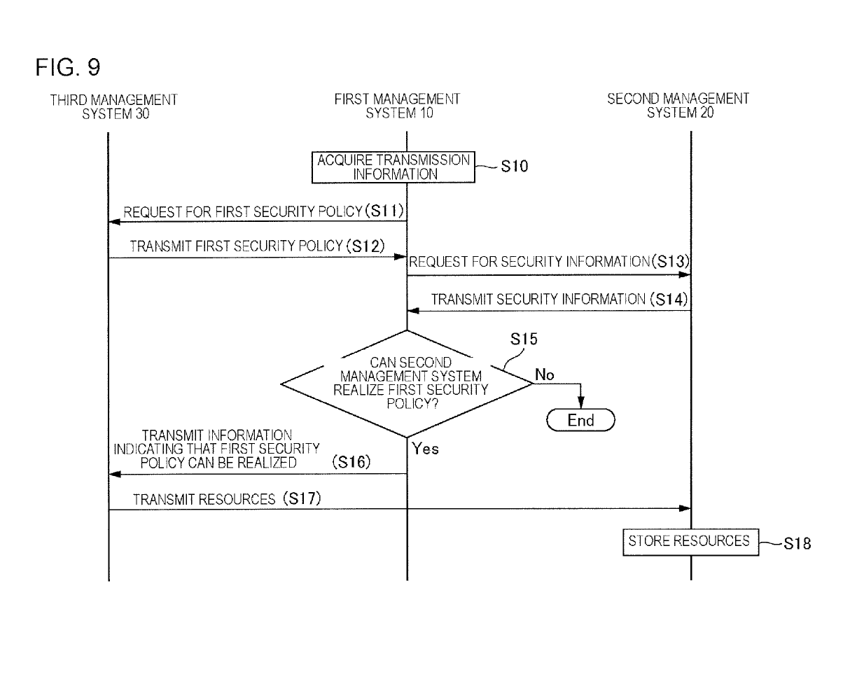

Next, an example of the process flow of a management method of the present exemplary embodiment will be described with reference to the sequence diagram shown in FIG. 9 and the functional block diagram shown in FIG. 1.

First, the transmission information acquisition unit 11 of the first management system 10 acquires transmission information indicating that the resources to realize an application held in the resource holding unit 31 of the third management system 30 are to be transmitted to the external data center (S10). It is assumed that information specifying an application to be transmitted is included in the transmission information.

Then, the extraction unit 12 of the first management system 10 specifies the application to be transmitted using the transmission information, and requests the first security policy, which is a security policy applied to the specified application and is a security policy to be realized in the data center of the transmission destination, from the security policy holding unit 32 of the third management system 30 (S11). Here, it is assumed that the extraction unit 12 requests all security policies applied to the application to be transmitted (all security policies applied to the application in the data center before transmission) as the first security policy. Then, the extraction unit 12 acquires the first security policy (some of the security policies shown in FIG. 2) transmitted from the third management system 30 in response to the request in S11 (S12).

After S10, the acquisition unit 14 of the first management system 10 requests security information, which indicates a security function that can be realized in the data center, from the data center (second management system 20 provided in the data center) of the transmission destination (candidate) (S13). Here, it is assumed that the acquisition unit 14 holds a list of candidates for the transmission destination data center shown in FIG. 6 and realizes the request of the security information described above using the address (IP address or the like) of the transmission destination data center described in the list. In the list, it is assumed that the data center where the second management system 20 is executed is described as a data center of the highest priority.

Then, the transmission request receiving unit 22 of the second management system 20 receives the request of the security information described above, and then the security information transmission unit 23 takes out the security information from the security information holding unit 21. Then, the security information transmission unit 23 transmits the taken-out security information to the first management system 10. Then, the acquisition unit 14 of the first management system. 10 acquires the security information transmitted from the second management system 20 in response to the request in S13 (S14).

The processes of S11 and S12 may be performed in this order after performing the processes of S13 and S14 in this order.

Then, the determination unit 13 of the first management system 10 determines whether or not the first security policy can be realized in the data center (data center where the second management system 20 is provided) of the transmission destination (candidate) based on the security information acquired in S14 (S15).

When it is determined that the data center (data center where the second management system 20 is provided) of the transmission destination (candidate) can realize the first security policy (Yes in S15), the determination unit 13 transmits information indicating the situation to the transmission unit 33 of the third management system. 30 (S16). In the information transmitted herein, information specifying an application to be transmitted and information (IP address or the like) specifying the data center (second management system 20 provided in the data center) of the transmission destination are assumed to be included.

Then, when the application to be transmitted is specified using the information transmitted in S16, the transmission unit 33 of the third management system 30 takes out the resources to realize the application from the resource holding unit 31. Then, the taken-out resources are transmitted to the data center (second management system 20 provided in the data center) of the transmission destination (S17). In this case, the transmission unit 33 may also transmit the security policy, which is applied to the application, to the second management system 20. In addition, when information regarding the type “privilege” shown in FIG. 2 is included in the security policy, the transmission unit 33 may also transmit information (refer to FIG. 8), in which the ID of each user who may use the application and the role (job title, role, and the like) of each user are correlated with each other, to the second management system 20.

Then, the receiving unit 24 of the second management system 20 that has received the resources described above stores the received resources in the second resource holding unit 25 (S18).

On the other hand, when it is determined that the data center (data center where the second management system 20 is provided) of the transmission destination (candidate) cannot realize the first security policy in S15 (No in S15), information indicating the situation is provided to the user through the output device, and the process is ended. Together with this information, information for discriminating between the first security policy that can be realized in the data center of the transmission destination (candidate) and the first security policy that cannot be realized in the data center of the transmission destination (candidate) may be output.

When it is determined that the data center (data center where the second management system 20 is provided) of the transmission destination (candidate) cannot realize the first security policy in S15 (No in S15), the determination unit 13 may transmit information indicating the situation to the acquisition unit 14. Then, the acquisition unit 14 may acquire security information from the data center of the next highest priority described in the list shown in FIG. 6. Then, the determination unit 13 may perform the same process as described above using the security information newly acquired by the acquisition unit 14.

According to the management system and the management method of the present exemplary embodiment described above, it is possible to reduce the human work involved in the transmission of resources. As a result, it is possible to advance the transmission of resources efficiently.

### Second Exemplary Embodiment

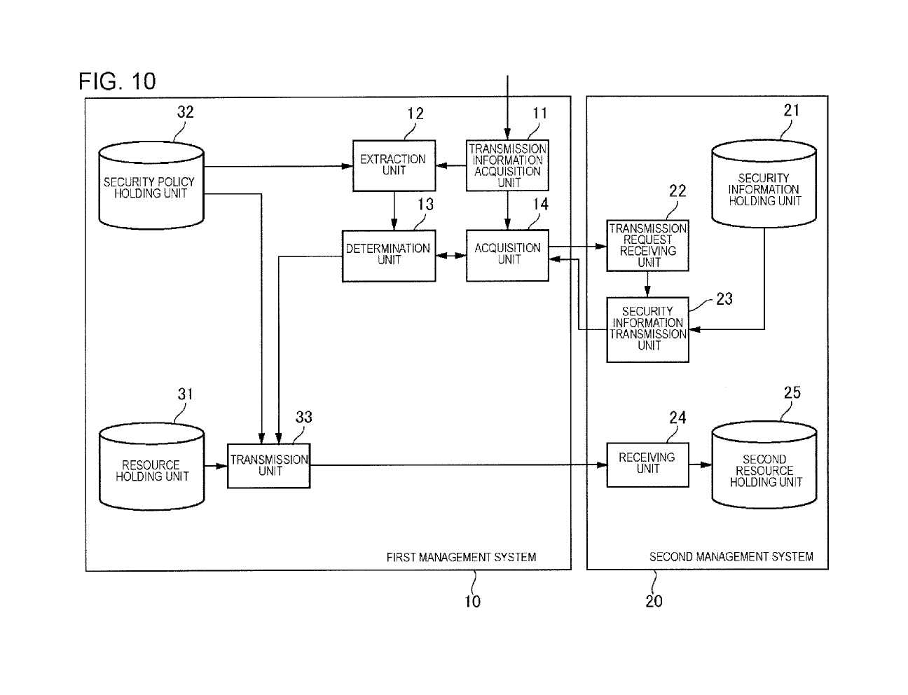

First, an entire image of the present exemplary embodiment will be described with reference to FIG. 10. The present exemplary embodiment is different from the first exemplary embodiment in that the first management system 10 and the third management system 30 described in the first exemplary embodiment are realized as the same system. Since other configurations are the same as those in the first exemplary embodiment, explanation thereof will not be repeated.

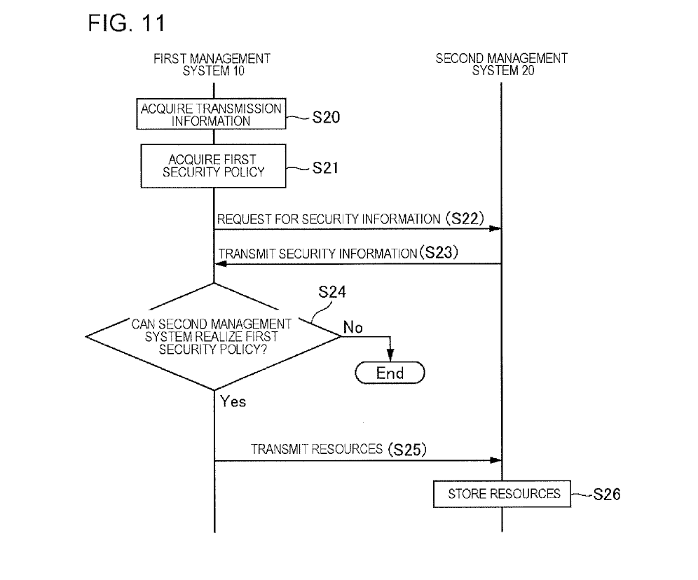

Here, an example of the process flow of a management method of the present exemplary embodiment will be described with reference to the sequence diagram shown in FIG. 11 and the functional block diagram shown in FIG. 10.

First, the transmission information acquisition unit 11 of the first management system 10 acquires transmission information indicating that the resources to realize an application held in the resource holding unit 31 of the first management system 10 are to be transmitted to the external data center (S20). It is assumed that information specifying an application to be transmitted is included in the transmission information.

Then, the extraction unit 12 of the first management system 10 specifies the application to be transmitted using the transmission information, and extracts the first security policy, which is a security policy applied to the specified application and is a security policy to be realized in the data center of the transmission destination, from the security policy holding unit 32 of the first management system 10 (S21). Here, it is assumed that the extraction unit 12 extracts all security policies applied to the application to be transmitted (all security policies applied to the application in the data center before transmission) as the first security policy.

After S20, the acquisition unit 14 of the first management system 10 requests security information, which indicates a security function that can be realized in the data center, from the data center (second management system 20 provided in the data center) of the transmission destination (candidate) (S22). Here, it is assumed that the acquisition unit 14 holds a list of candidates for the transmission destination data center shown in FIG. 6 and realizes the request of the security information described above using the address (IP address or the like) of the transmission destination data center described in the list. In the list, it is assumed that the data center where the second management system 20 is executed is described as a data center of the highest priority.

Then, the transmission request receiving unit 22 of the second management system 20 receives the request of the security information described above, and then the security information transmission unit 23 takes out the security information from the security information holding unit 21. Then, the security information transmission unit 23 transmits the taken-out security information to the first management system 10. Then, the acquisition unit 14 of the first management system. 10 acquires the security information transmitted from the second management system 20 in response to the request in S22 (S23).

The process of S21 may be performed after performing the processes of S22 and S23 in this order.

Then, the determination unit 13 of the first management system 10 determines whether or not the first security policy can be realized in the data center (data center where the second management system 20 is provided) of the transmission destination (candidate) based on the security information acquired in S23 (S24).

When it is determined that the data center (data center where the second management system 20 is provided) of the transmission destination (candidate) can realize the first security policy (Yes in S24), the determination unit 13 transmits information indicating the situation to the transmission unit 33 of the first management system 10. In the information transmitted herein, information specifying an application to be transmitted and information (IP address or the like) specifying the data center (second management system 20 provided in the data center) of the transmission destination are assumed to be included.

Then, when the application to be transmitted is specified using the information described above, the transmission unit 33 takes out the resources to realize the application from the resource holding unit 31. Then, the taken-out resources are transmitted to the data center (second management system 20 provided in the data center) of the transmission destination (S25). In this case, the transmission unit 33 may also transmit the security policy, which is applied to the application, to the second management system 20. In addition, when information regarding the type “privilege” shown in FIG. 2 is included in the security policy, the transmission unit 33 may also transmit information (refer to FIG. 8), in which the ID of each user who may use the application and the role (job title, role, and the like) of each user are correlated with each other, to the second management system 20.

Then, the receiving unit 24 of the second management system 20 that has received the resources described above stores the received resources in the second resource holding unit 25 (S26).

On the other hand, when it is determined that the data center (data center where the second management system 20 is provided) of the transmission destination (candidate) cannot realize the first security policy in S24 (No in S24), information indicating the situation is provided to the user through the output device, and the process is ended. Together with this information, information for discriminating between the first security policy that can be realized in the data center of the transmission destination (candidate) and the first security policy that cannot be realized in the data center of the transmission destination (candidate) may be output.

When it is determined that the data center (data center where the second management system 20 is provided) of the transmission destination (candidate) cannot realize the first security policy in S24 (No in S24), the determination unit 13 may transmit information indicating the situation to the acquisition unit 14. Then, the acquisition unit 14 may acquire security information from the data center of the next highest priority described in the list shown in FIG. 6. Then, the determination unit 13 may perform the same process as described above using the security information newly acquired by the acquisition unit 14.

According to the management system and the management method of the present exemplary embodiment described above, the same operations and effects as in the first exemplary embodiment can be realized.

### Third Exemplary Embodiment

First, the outline of the present exemplary embodiment will be described. In the first exemplary embodiment, the first management system 10 determines “whether or not the data center where the second management system 20 is provided can realize the first security policy”. In contrast, in the present exemplary embodiment, the second management system 20 performs the determination described above.

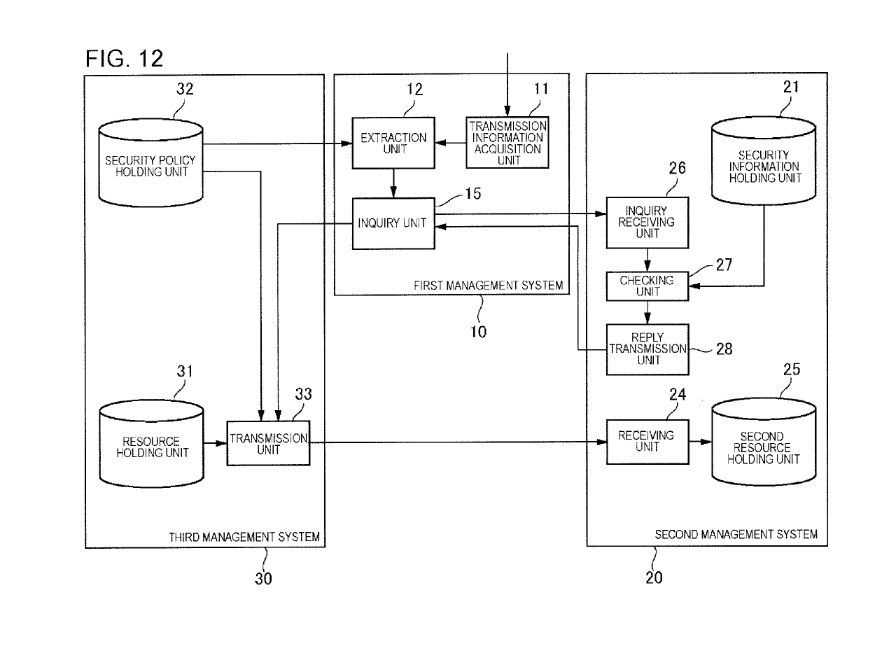

Next, an entire image of the present exemplary embodiment will be described with reference to FIG. 12. The present exemplary embodiment is different from the first exemplary embodiment in the following points.

(1) A point that the first management system 10 of the present exemplary embodiment does not include the determination unit 13 and the acquisition unit 14, which are included in the first management system 10 of the first exemplary embodiment, and includes an inquiry unit 15 instead.

(2) A point that the second management system 20 of the present exemplary embodiment does not include the transmission request receiving unit 22 and the security information transmission unit 23, which are included in the second management system 20 of the first exemplary embodiment, and includes an inquiry receiving unit 26, a checking unit 27, and a reply transmission unit 28 instead.

(3) A point that the configuration of the transmission unit 33 provided in the third management system 30 of the present exemplary embodiment is different in part from the configuration of the transmission unit 33 provided in the third management system 30 of the first exemplary embodiment.

Hereinafter, the differences will be described in detail. In addition, since other configurations are the same as those in the first exemplary embodiment, explanation thereof will not be repeated.

### <First Management System 10>

Since the configuration of the transmission information acquisition unit 11 and the extraction unit 12 is the same as that in the first exemplary embodiment, explanation thereof will not be repeated.

When the transmission information acquisition unit 11 acquires transmission information and the extraction unit 12 extracts a first security policy as in the first exemplary embodiment, the inquiry unit 15 inquires of the external data center (second management system 20 provided in the data center) of the transmission destination (candidate) whether or not the first security policy can be realized in the data center. The inquiry unit 15 acquires a reply to the inquiry from the external data center (second management system 20 provided in the data center) of the transmission destination (candidate).

When information (IP address or the like) specifying the external data center (second management system 20 provided in the data center) of the transmission destination (candidate) is included in the transmission information, the inquiry unit 15 may realize communication (inquiry) with the external data center (second management system 20 provided in the data center) using the information. Alternatively, the inquiry unit 15 may hold a list of candidates for the transmission destination data center shown in FIG. 6 in advance, and realize the above-described communication with the external data center of the transmission destination (candidate) using the list. In the list shown in FIG. 6, addresses (IP addresses or the like) of a plurality of external data centers are registered, and the priorities of transmission are given. The inquiry unit 15 may send the above-described inquiry in order from the high-priority data center.

Then, when a reply indicating that the first security policy can be realized in the data center is acquired from the external data center (second management system 20 provided in the data center) of the transmission destination (candidate), the inquiry unit 15 can transmit information indicating the situation (hereinafter, referred to as “first information”) to the transmission unit 33. In the first information transmitted herein, information specifying an application to be transmitted and information (IP address or the like) specifying the external data center (second management system 20 provided in the data center) of the transmission destination may be included.

On the other hand, when a reply indicating that the first security policy cannot be realized in the data center is acquired from the external data center (second management system 20 provided in the data center) of the transmission destination (candidate), the inquiry unit 15 may output information indicating the situation to the user (administrator or the like of the third management system). The output can be realized using all kinds of output devices, such as a display, a speaker, a printer, and an e-mail.

In addition, when a reply indicating that the first security policy cannot be realized in the data center is acquired from the external data center (second management system 20 provided in the data center) of the transmission destination (candidate), the inquiry unit 15 may send the same inquiry as described above to the data center of the next highest priority using the list of candidates for the transmission destination shown in FIG. 6, for example.

The first management system 10 of the present exemplary embodiment can be realized by installing the following program in a computer, for example.

A program causing a computer to function as: a transmission information acquisition unit that acquires transmission information indicating that resources to realize an application held in a resource holding unit are to be transmitted to an external data center; an extraction unit that extracts a first security policy, which is a security policy applied to the application to be transmitted and is a security policy to be realized in the external data center, from a security policy holding unit that holds the security policy applied to the application when the transmission information acquisition unit acquires the transmission information; and an inquiry unit that inquires of the external data center whether or not the first security policy is realizable in the external data center and acquires a reply from the external data center.

### <Third Management System 30>

Since the configuration of the resource holding unit 31 and the security policy holding unit 32 is the same as that in the first exemplary embodiment, explanation thereof will not be repeated.

When the inquiry unit 15 acquires a “reply indicating that the first security policy can be realized in the external data center (data center where the second management system 20 is provided) of the transmission destination”, the transmission unit 33 transmits the resources to realize the application to be transmitted to the external data center (second management system 20 provided in the data center) of the transmission destination.

That is, when the first information is acquired from the inquiry unit 15, the transmission unit 33 specifies the application to be transmitted and the transmission destination using information included in the first information, and then takes out resources to realize the specified application from the resource holding unit 31 and transmits the resources to the specified transmission destination. In this case, the transmission unit 33 may also transmit the security policy, which is applied to the application, to the second management system 20. In addition, when information regarding the type “privilege” shown in FIG. 2 is included in the security policy, the transmission unit 33 may also transmit information (refer to FIG. 8), in which the ID of each user who may use the application and the role (job title, role, and the like) of each user are correlated with each other, to the second management system 20.

### <Second Management System 20>

Since the configuration of the security information holding unit 21, the receiving unit 24, and the second resource holding unit 25 is the same as that in the first exemplary embodiment, explanation thereof will not be repeated.

The inquiry receiving unit 26 receives an inquiry regarding whether or not a predetermined security policy (first security policy) can be realized in its own data center (data center of the receiving destination) from the external data center. In the inquiry, information indicating the content of the first security policy is included.

When the inquiry receiving unit 26 receives the inquiry, the checking unit 27 determines whether or not the predetermined security policy (first security policy) can be realized in its own data center (data center of the receiving destination) based on the security information held in the security information holding unit 21. The determination process of the checking unit 27 can be the same as the process of the determination unit 13 described in the first exemplary embodiment. Then, the checking unit 27 transmits a determination result, which indicates that the first security policy “can be realized” or “cannot be realized” in its own data center (data center of the receiving destination), to the reply transmission unit 28. Together with the determination result, the checking unit 27 may transmit information for discriminating between the first security policy, which can be realized, and the first security policy, which cannot be realized, to the reply transmission unit 28.

The reply transmission unit 28 transmits the determination result received from the checking unit 27 to the external data center that has sent the above-described inquiry. When the information for discriminating between the first security policy that can be realized and the first security policy that cannot be realized is received from the checking unit 27, the reply transmission unit 28 may also transmit the information to the external data center.

The second management system 20 of the present exemplary embodiment can be realized by installing the following program in a computer, for example.

A program for receiving resources to realize an application from an external data center, the program causing a computer to function as: a security information holding unit that holds security information indicating a security function realizable in a data center of a receiving destination; an inquiry receiving unit that receives, from the external data center, an inquiry regarding whether or not a predetermined security policy is realizable in the data center of the receiving destination; a checking unit that determines whether or not the predetermined security policy is realizable in the data center of the receiving destination based on the security information when the inquiry receiving unit receives the inquiry; and a reply transmission unit that transmits a determination result of the checking unit to the external data center.

### <Process Flow>

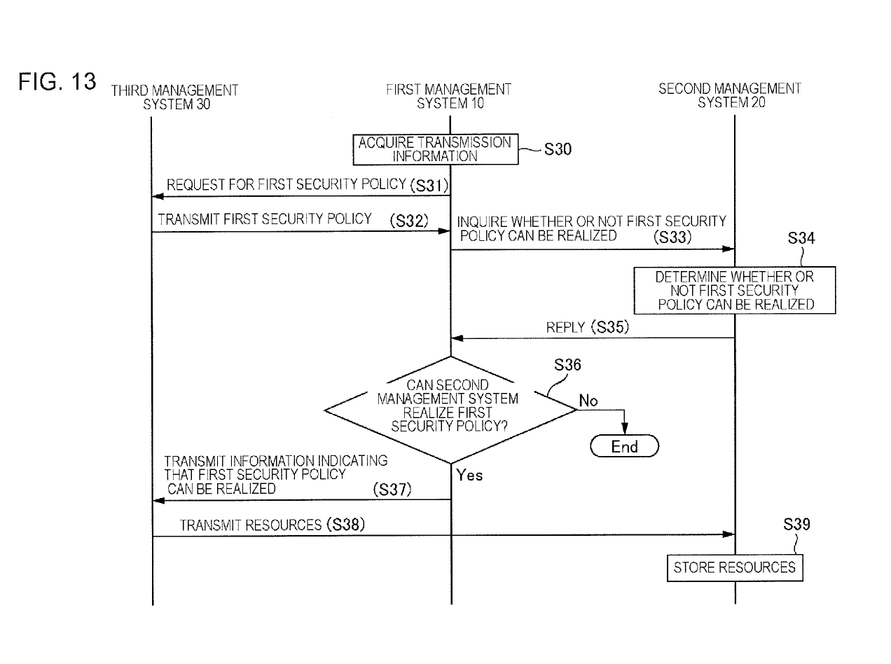

Next, an example of the process flow of a management method of the present exemplary embodiment will be described with reference to the sequence diagram shown in FIG. 13 and the functional block diagram shown in FIG. 12.

First, the transmission information acquisition unit 11 of the first management system 10 acquires transmission information indicating that the resources to realize an application held in the resource holding unit 31 of the third management system 30 are to be transmitted to the external data center (S30). It is assumed that information specifying an application to be transmitted is included in the transmission information.

Then, the extraction unit 12 of the first management system 10 specifies the application to be transmitted using the transmission information, and requests the first security policy, which is a security policy applied to the specified application and is a security policy to be realized in the data center of the transmission destination, from the security policy holding unit 32 of the third management system 30 (S31). Here, it is assumed that the extraction unit 12 requests all security policies applied to the application to be transmitted (all security policies applied to the application in the data center before transmission) as the first security policy. Then, the extraction unit 12 acquires the first security policy (some of the security policies shown in FIG. 2) transmitted from the third management system 30 in response to the request in S31 (S32).

Then, the inquiry unit 15 of the first management system 10 inquires of the data center (second management system 20 provided in the data center) of the transmission destination (candidate) whether or not the first security policy can be realized in the data center (S33). Here, it is assumed that the inquiry unit 15 holds a list of candidates for the transmission destination data center shown in FIG. 6 and sends the inquiry described above using the address (IP address or the like) of the transmission destination data center described in the list. In the list, it is assumed that the data center where the second management system 20 is executed is described as a data center of the highest priority.

Then, the inquiry receiving unit 26 of the second management system 20 receives the above-described inquiry, and then the checking unit 27 takes out security information from the security information holding unit 21. Then, the checking unit 27 determines whether or not the first security policy can be realized in its own data center based on the taken-out security information (S34). Then, the reply transmission unit 28 transmits the determination result (“can be realized” or “cannot be realized”) of the checking unit 27 to the first management system 10. Then, the inquiry unit 15 of the first management system 10 acquires the reply (S35). When the determination result of the checking unit 27 is “cannot be realized”, the reply transmission unit 28 may receive information for discriminating between the first security policy that can be realized and the first security policy that cannot be realized from the checking unit 27, and may also transmit the information to the first management system 10.

Then, when the content of the reply received by the inquiry unit 15 in S35 is that the first security policy can be realized in the data center (data center where the second management system 20 is provided) of the transmission destination (candidate) (Yes in S36), the inquiry unit 15 transmits information indicating the situation to the transmission unit 33 of the third management system. 30 (S37). In the information transmitted herein, information specifying an application to be transmitted and information (IP address or the like) specifying the data center (second management system 20 provided in the data center) of the transmission destination are assumed to be included.

Then, when the application to be transmitted is specified using the information transmitted in S37, the transmission unit 33 of the third management system 30 takes out the resources to realize the application from the resource holding unit 31. Then, the taken-out resources are transmitted to the data center (second management system 20 provided in the data center) of the transmission destination (S38). In this case, the transmission unit 33 may also transmit the security policy, which is applied to the application, to the second management system 20. In addition, when information regarding the type “privilege” shown in FIG. 2 is included in the security policy, the transmission unit 33 may also transmit information (refer to FIG. 8), in which the ID of each user who may use the application and the role (job title, role, and the like) of each user are correlated with each other, to the second management system 20.

Then, the receiving unit 24 of the second management system 20 that has received the resources described above stores the received resources in the second resource holding unit 25 (S39).

On the other hand, when the content of the reply received by the inquiry unit 15 in S35 is that the first security policy cannot be realized in the data center (data center where the second management system 20 is provided) of the transmission destination (candidate) (No in S36), the inquiry unit 15 provides information indicating the situation to the user through the output device, and the process is ended. Together with this information, information for discriminating between the first security policy that can be realized in the data center of the transmission destination (candidate) and the first security policy that cannot be realized in the data center of the transmission destination (candidate) may be output.

In addition, when the content of the reply received by the inquiry unit 15 in S35 is that the first security policy cannot be realized in the data center (data center where the second management system 20 is provided) of the transmission destination (candidate) (No in S36), the inquiry unit 15 may inquire of the data center of the next highest priority, which is described in the list shown in FIG. 6, whether or not the first security policy can be realized in the data center, and perform the same process as described above.

According to the management system and the management method of the present exemplary embodiment described above, the same operations and effects as in the first exemplary embodiment can be realized.

### Fourth Exemplary Embodiment

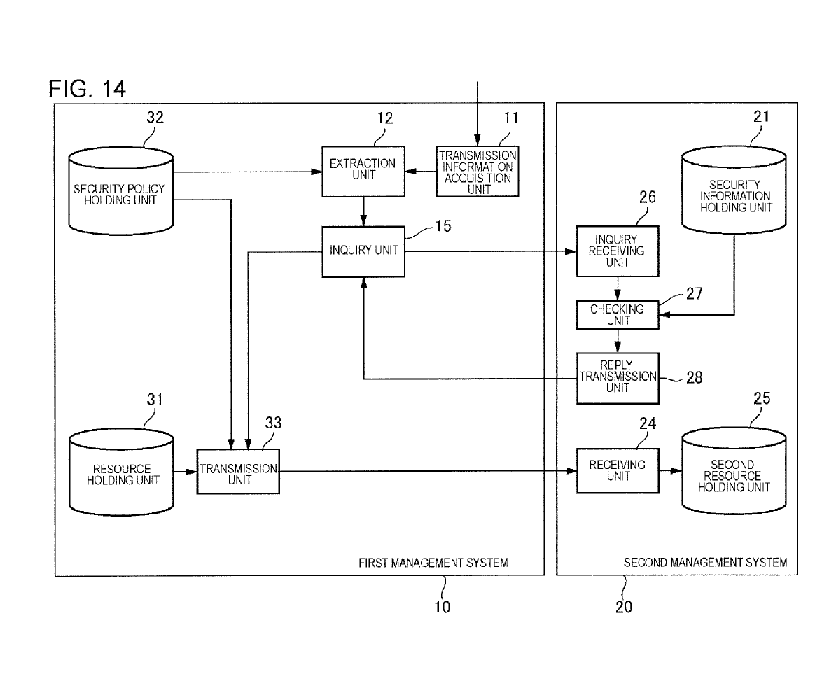

First, an entire image of the present exemplary embodiment will be described with reference to FIG. 14. The present exemplary embodiment is different from the third exemplary embodiment in that the first management system 10 and the third management system 30 described in the third exemplary embodiment are realized as the same system. Since other configurations are the same as those in the third exemplary embodiment, explanation thereof will not be repeated.

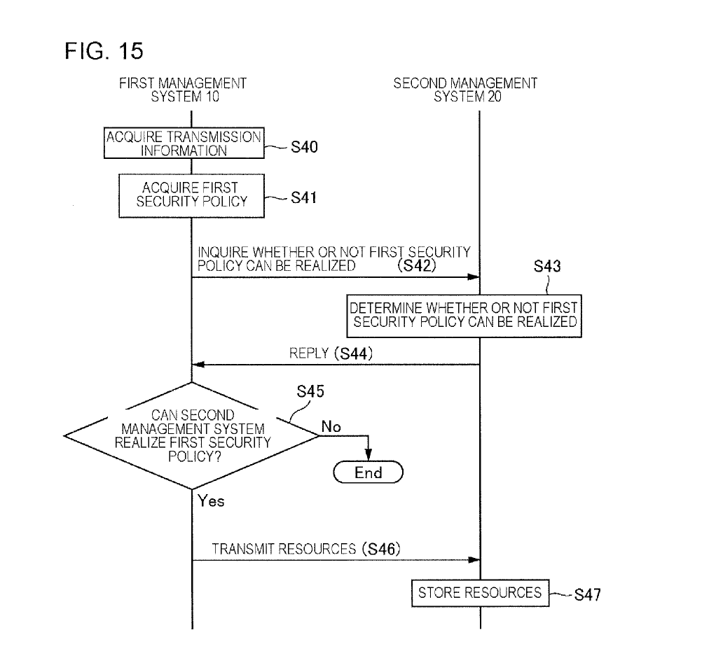

Here, an example of the process flow of a management method of the present exemplary embodiment will be described with reference to the sequence diagram shown in FIG. 15 and the functional block diagram shown in FIG. 14.

First, the transmission information acquisition unit 11 of the first management system 10 acquires transmission information indicating that the resources to realize an application held in the resource holding unit 31 are to be transmitted to the external data center (S40). It is assumed that information specifying an application to be transmitted is included in the transmission information.

Then, the extraction unit 12 of the first management system 10 specifies the application to be transmitted using the transmission information, and requests the first security policy, which is a security policy applied to the specified application and is a security policy to be realized in the data center of the transmission destination, from the security policy holding unit 32 of the first management system 10. Here, it is assumed that the extraction unit 12 requests all security policies applied to the application to be transmitted (all security policies applied to the application in the data center before transmission) as the first security policy. Then, the extraction unit 12 acquires the first security policy (some of the security policies shown in FIG. 2) taken out from the security policy holding unit 32 in response to the above request (S41).

Then, the inquiry unit 15 of the first management system 10 inquires of the data center (second management system 20 provided in the data center) of the transmission destination (candidate) whether or not the first security policy can be realized in the data center (S42). Here, it is assumed that the inquiry unit 15 holds a list of candidates for the transmission destination data center shown in FIG. 6 and sends the inquiry described above using the address (IP address or the like) of the transmission destination data center described in the list. In the list, it is assumed that the data center where the second management system 20 is executed is described as a data center of the highest priority.

Then, the inquiry receiving unit 26 of the second management system 20 receives the above-described inquiry, and then the checking unit 27 takes out security information from the security information holding unit 21. Then, the checking unit 27 determines whether or not the first security policy can be realized in its own data center based on the taken-out security information (S43). Then, the reply transmission unit 28 transmits the determination result (“can be realized” or “cannot be realized”) of the checking unit 27 to the first management system 10. Then, the inquiry unit 15 of the first management system 10 acquires the reply (S44). When the determination result of the checking unit 27 is “cannot be realized”, the reply transmission unit 28 may receive information for discriminating between the first security policy that can be realized and the first security policy that cannot be realized from the checking unit 27, and may also transmit the information to the first management system 10.

Then, when the content of the reply received by the inquiry unit 15 in S44 is that the first security policy can be realized in the data center (data center where the second management system 20 is provided) of the transmission destination (candidate) (Yes in S45), the inquiry unit 15 transmits information indicating the situation to the transmission unit 33 of the first management system 10. In the information transmitted herein, information specifying an application to be transmitted and information (IP address or the like) specifying the data center (second management system 20 provided in the data center) of the transmission destination are assumed to be included.

Then, when the application to be transmitted is specified using the information described above, the transmission unit 33 takes out the resources to realize the application from the resource holding unit 31. Then, the taken-out resources are transmitted to the data center (second management system 20 provided in the data center) of the transmission destination (S46). In this case, the transmission unit 33 may also transmit the security policy, which is applied to the application, to the second management system 20. In addition, when information regarding the type “privilege” shown in FIG. 2 is included in the security policy, the transmission unit 33 may also transmit information (refer to FIG. 8), in which the ID of each user who may use the application and the role (job title, role, and the like) of each user are correlated with each other, to the second management system 20.

Then, the receiving unit 24 of the second management system 20 that has received the resources described above stores the received resources in the second resource holding unit 25 (S47).

On the other hand, when the content of the reply received by the inquiry unit 15 in S44 is that the first security policy cannot be realized in the data center (data center where the second management system 20 is provided) of the transmission destination (candidate) (No in S45), the inquiry unit 15 provides information indicating the situation to the user through the output device, and the process is ended. Together with this information, information for discriminating between the first security policy that can be realized in the data center of the transmission destination (candidate) and the first security policy that cannot be realized in the data center of the transmission destination (candidate) may be output.

In addition, when the content of the reply received by the inquiry unit 15 in S44 is that the first security policy cannot be realized in the data center (data center where the second management system 20 is provided) of the transmission destination (candidate) (No in S45), the inquiry unit 15 may inquire of the data center of the next highest priority, which is described in the list shown in FIG. 6, whether or not the first security policy can be realized in the data center, and perform the same process as described above.

According to the management system and the management method of the present exemplary embodiment described above, the same operations and effects as in the third embodiment can be realized.

This application claims priority from Japanese Patent Application No. 2012-013455, filed on Jan. 25, 2012, the entire contents of which are incorporated herein.

1. A management system, comprising:
a transmission information acquisition unit that acquires transmission information indicating that resources to realize an application held in a resource holding unit are to be transmitted to an external data center;
an extraction unit that extracts a first security policy, which is a security policy applied to the application to be transmitted and is a security policy to be realized in the external data center, from a security policy holding unit that holds the security policy applied to the application when the transmission information acquisition unit acquires the transmission information;
an acquisition unit that acquires security information, which indicates a security function realizable in the external data center, from the external data center when the transmission information acquisition unit acquires the transmission information; and
a determination unit that determines whether or not the first security policy is realizable in the external data center based on the security information.

2. The management system according to claim 1, further comprising:
a transmission unit that transmits the resources to realize the application to be transmitted to the external data center when the determination unit determines that the first security policy is realizable in the external data center.

3. A management system, comprising:
a transmission information acquisition unit that acquires transmission information indicating that resources to realize an application held in a resource holding unit are to be transmitted to an external data center;
an extraction unit that extracts a first security policy, which is a security policy applied to the application to be transmitted and is a security policy to be realized in the external data center, from a security policy holding unit that holds the security policy applied to the application when the transmission information acquisition unit acquires the transmission information; and
an inquiry unit that inquires of the external data center whether or not the first security policy is realizable in the external data center and acquires a reply from the external data center.

4. The management system according to claim 3, further comprising:
a transmission unit that transmits the resources to realize the application to be transmitted to the external data center when the inquiry unit acquires a reply indicating that the first security policy is realizable in the external data center.

5. The management system according to claim 2,
wherein the transmission unit transmits the security policy, which is applied to the application to be transmitted, together with the resources.

6. The management system according to claim 1, further comprising:
the security policy holding unit.

7. The management system according to claim 1, further comprising:
the resource holding unit.

8. The management system according to claim 1,
wherein the resource holding unit holds the resources regarding a plurality of the applications, and
information specifying at least one of the plurality of applications as the application to be transmitted is included in the transmission information acquired by the transmission information acquisition unit.

9. A management system that receives resources to realize an application from an external data center, comprising:
a security information holding unit that holds security information indicating a security function realizable in a data center of a receiving destination;
a transmission request receiving unit that receives a request for transmission of the security information from the external data center; and
a security information transmission unit that takes out the security information from the security information holding unit and transmits the security information to the external data center when the transmission request receiving unit receives the request for transmission.

10. A management system that receives resources to realize an application from an external data center, comprising:
a security information holding unit that holds security information indicating a security function realizable in a data center of a receiving destination;
an inquiry receiving unit that receives, from the external data center, an inquiry regarding whether or not a predetermined security policy is realizable in the data center of the receiving destination;
a checking unit that determines whether or not the predetermined security policy is realizable in the data center of the receiving destination based on the security information when the inquiry receiving unit receives the inquiry; and
a reply transmission unit that transmits a determination result of the checking unit to the external data center.

11. A non-transitory storage medium storing a program causing a computer to function as:
a transmission information acquisition unit that acquires transmission information indicating that resources to realize an application held in a resource holding unit are to be transmitted to an external data center;
an extraction unit that extracts a first security policy, which is a security policy applied to the application to be transmitted and is a security policy to be realized in the external data center, from a security policy holding unit that holds the security policy applied to the application when the transmission information acquisition unit acquires the transmission information;
an acquisition unit that acquires security information, which indicates a security function realizable in the external data center, from the external data center when the transmission information acquisition unit acquires the transmission information; and
a determination unit that determines whether or not the first security policy is realizable in the external data center based on the security information.

12. A non-transitory storage medium storing a program causing a computer to function as:
a transmission information acquisition unit that acquires transmission information indicating that resources to realize an application held in a resource holding unit are to be transmitted to an external data center;
an extraction unit that extracts a first security policy, which is a security policy applied to the application to be transmitted and is a security policy to be realized in the external data center, from a security policy holding unit that holds the security policy applied to the application when the transmission information acquisition unit acquires the transmission information; and
an inquiry unit that inquires of the external data center whether or not the first security policy is realizable in the external data center and acquires a reply from the external data center.

13. A non-transitory storage medium storing a program for receiving resources to realize an application from an external data center, the program causing a computer to function as:
a security information holding unit that holds security information indicating a security function realizable in a data center of a receiving destination;
a transmission request receiving unit that receives a request for transmission of the security information from the external data center; and
a security information transmission unit that takes out the security information from the security information holding unit and transmits the security information to the external data center when the transmission request receiving unit receives the request for transmission.

14. A non-transitory storage medium storing a program for receiving resources to realize an application from an external data center, the program causing a computer to function as:
a security information holding unit that holds security information indicating a security function realizable in a data center of a receiving destination;
an inquiry receiving unit that receives, from the external data center, an inquiry regarding whether or not a predetermined security policy is realizable in the data center of the receiving destination;
a checking unit that determines whether or not the predetermined security policy is realizable in the data center of the receiving destination based on the security information when the inquiry receiving unit receives the inquiry; and
a reply transmission unit that transmits a determination result of the checking unit to the external data center.

15. A management method causing a computer to execute:
a transmission information acquisition step of acquiring transmission information indicating that resources to realize an application held in a resource holding unit are to be transmitted to an external data center;
an extraction step of extracting a first security policy, which is a security policy applied to the application to be transmitted and is a security policy to be realized in the external data center, from a security policy holding unit that holds the security policy applied to the application when the transmission information is acquired in the transmission information acquisition step;
an acquisition step of acquiring security information, which indicates a security function realizable in the external data center, from the external data center when the transmission information is acquired in the transmission information acquisition step; and
a determination step of determining whether or not the first security policy is realizable in the external data center based on the security information.

16. A management method causing a computer to execute:
a transmission information acquisition step of acquiring transmission information indicating that resources to realize an application held in a resource holding unit are to be transmitted to an external data center;
an extraction step of extracting a first security policy, which is a security policy applied to the application to be transmitted and is a security policy to be realized in the external data center, from a security policy holding unit that holds the security policy applied to the application when the transmission information is acquired in the transmission information acquisition step; and
an inquiry step of inquiring of the external data center whether or not the first security policy is realizable in the external data center and acquiring a reply from the external data center.

17. A management method for receiving resources to realize an application from an external data center, the method causing a computer to execute:
a transmission request receiving step of receiving a request for transmission of security information from the external data center; and
a security information transmission step of taking out the security information from a security information holding unit, which holds security information indicating a security function realizable in a data center of a receiving destination, and transmitting the security information to the external data center when the request for transmission is received in the transmission request receiving step.

18. A management method for receiving resources to realize an application from an external data center, the method causing a computer to execute:
an inquiry receiving step of receiving, from the external data center, an inquiry regarding whether or not a predetermined security policy is realizable in a data center of the receiving destination;
a checking step of determining whether or not the predetermined security policy is realizable in the data center of the receiving destination based on security information, which indicates a security function realizable in the data center of the receiving destination and is held in a security information holding unit, when the inquiry is received in the inquiry receiving step; and
a reply transmission step of transmitting a determination result in the checking step to the external data center.
